(19) United States
(12) Patent Application Publication
(10) Pub. No.: US 2013/0006843 A1
(43) Pub. Date: Jan. 3, 2013

(54) QUANTATIVE DIVIDENDS METHOD AND SYSTEM

(76) Inventor: Yeap Tralvex, Central Meadows (SG)

(21) Appl. No.: 13/635,376

(22) PCT Filed: Apr. 8, 2010
(86) PCT No.: PCT/SG10/00141

§ 371 Date: Sep. 14, 2012

(51) Int. Cl. G06Q 40/06

(52) U.S. Cl. 705/37

(57) ABSTRACT

A method of generating trading strategies, comprising the steps of: providing a system for generating trading strategies for dividend-based stocks, loading a first database containing basic information of stock and a second database containing financial information of stock into the system, computing maximum trading days of the stock, mapping of the first database and second database of the stock to a trading day and an alternative trading day, computing maximum number of trading pairs based on the maximum trading days of the stock, if trading long, computing historical returns for all trading pairs, computing buy/sell differences and actual trading dates and price of all trading pairs, if trading short, computing historical returns for all trading pairs, compute short/cover price differences and actual trading dates and price of all trading pairs, ranking a list of trading pairs based on one or more corresponding ranking criteria for trading long and trading short.

### CROSS-REFERENCE TO RELATED APPLICATION(S)

This application is a National Phase Patent Application and claims priority to and benefit of International Application Number PCT/SG2010/000141, filed on Apr. 8, 2010, the entire disclosure of which is incorporated herein by reference.

### FIELD OF THE INVENTION

The present invention relates to the field of financial engineering and more specifically a method and a system for generating hedge fund trading strategies for dividend-based equities.

### BACKGROUND

There exist at least three analytical methods analysing prices of an equity in the stock exchange.

The first well-known analytical method is called Fundamental analysis and a large part of the analysis involve the analytics of a company's financial statements such as revenue, expenses, assets, liability and other financial aspects of a company. More specifically, the financial analysis involved computing financial variables such as “book value”, “dividend yield”, “intrinsic value”, “price/earnings ratio”, “price/earnings to growth ratio”, “price/cash ratio”, “price/sales ratio”, etc. In most cases, portfolio managers who use fundamental analysis in the selection of a portfolio of stocks expect a net positive returns over a long period of time. A long period of time is defined as a few months to a few years. Some examples of inventions that utilize forms of fundamental analysis are disclosed in U.S. Pat. No. 6,317,726, European Patent Application No. EP2126823A2 and PCT Patent Application No. PCT/US2005/040807.

The second well-known analytical method is called Technical analysis and was reviewed in Levy, R. A., “Conceptual Foundations of Technical Analysis”, Financial Analysts Journal, July/August 66, Vol. 22 Issue 4, p 83, 7 p. Technical analysis is the research of price action in markets through the use of charts and quantitative techniques to predict Mr. Market bidding or asking price. In contrast to fundamental analysis, technical analysis does not make use of financial information of the company. Instead, numerous quantitative techniques are at the disposal of portfolio managers who use technical analysis in their selection of a portfolio of stocks, and such technical analysis includes “Bollinger Bands”, “Momentum”, “On Balance Volume”, “Relative Strength Index”, etc. Technical analysis is generally favoured by traders or portfolio managers who expect a short-term outcome to their selection of the stocks portfolio. Short-term is defined as a few days to a few weeks. Some examples of inventions that utilize forms of technical analysis are disclosed in US Patent Application No. 2004/0225592, European Patent Application No. EP1109122A2 and PCT Patent Application PCT/US00/40666.

The third analytical method is an integration of both Fundamental analysis and Technical analysis.

In addition, other analytical methods include historical stock price optimizers, seasonality trading method, lunar and solar rhythms trading method, maximum entropy method for the analysis of market cycles, neutral networks trading method and genetic algorithm based trading method. Refer to Katz, J. & McCormick, D., 2000. The Encyclopaedia of Trading Strategies 1st ed., McGraw-Hill for more details.

There exist many more investment and trading methods with the objective of improving the returns in equities. More specifically, some of the known dividend-based stock trading methods and strategies are described as follows. Dividend-based stocks are equities of corporations that issue dividends to its shareholders. Typical forms of dividends payments are in cash, shares of stock shares or a combination of both.

“Dogs of the Dow” is an investment strategy popularized by Michael O'Higgins, in 1991 which proposes that an investor annually select for investment the ten Dow Jones Industrial Average stocks whose dividend is the highest fraction of their price. Basically, at the end of every year, you buy the 10 highest-yielding stocks of the 30 in the Dow Jones Industrial Average and put equal amounts of money into the 10 issues. Hold the stocks until the end of the following year, and repeat the process.

“The Puppies and Pigs” is another investment strategy where ‘There is the ‘Flying Five,’ where you buy the five lowest-priced stocks among the 10 highest yielders on the Dow, keep them for a year, and then, like the Dogs, sell those that no longer qualify and then buy the new Flying Five.

“Unit Investment Trust and Mutual Funds Based on the Dogs” is also another investment strategy where the Unit Investment Trust and Mutual Funds are operated based on “Dogs of the Dow”.

“S & P 10 Highest Dividend Yielders” is a variation of “Dogs of the Dow” where the top 10 highest yielding stocks are ‘among the 100 largest-cap stocks in the S & P 500’.

“Geraldine Weiss's Strategy” is another investment strategy where this method ‘focuses on buying blue-chip stocks whose dividend yields are near the high of their historical ranges and selling them when they drift lower’.

“Relative Dividend Yield” is an investment strategy devised by Anthony Spare, where this method is a variation of “Geraldine Weiss's Strategy” and instead of using the historical ranges of the stock itself, the comparison is with S & P 500 index, “If a stock's yield is considerably higher than that of the index, the stock is buy”. Furthermore, “As in the Dogs of the Dow strategy and Ms. Weiss's approach, most of Spare's stocks with buy signals are depressed and the companies are encountering difficulties, usually temporary . . . ”.

“Goldman Sachs Dividend Strategy” is an investment strategy, where the strategy involved investing in “stocks of companies with low yields and high dividend increases . . . ”, instead of “stocks with high yields and dividend cuts”.

“25% Cash Machine” is another investment strategy, where there is a basket of “special-case, high-yield securities . . . which deliver around 10 percent income and 15 percent (at least) capital gains annually.” Furthermore, in terms of time frame of stock ownership, “this strategy is that it is not meant to be a trading account. You will not be looking to book short-term gains in 30, 60 or 90 days after you enter a position . . . . What you should be looking to do is hold each and every position you have for years to come.”

In the Journal of Financial Economics, Karpoff, J. M. & Walkling, R. A. wrote about the Dividend capture in NASDAQ stocks. Basically, the Dividend capture is the practice of buying a stock shortly before its ex-dividend day and selling it soon after.

In addition, US Patent Application No. 20090157564 ('564) describes a computerized method of selecting a security for purchase and for sale. '564 patent application discloses an invention that uses dividend yield for generating investing strategies.

A drawn back of the above described examples of investment and trading strategies is that, dividend strategies suitable for investing purpose come with a time frame of several months to years. A second drawn back is that, there are no explicit Enter and Exit trading signals. A third drawn back is that, securing profits are based on the expectation of receiving dividends and capital gains from the invested stocks—securing profits from the payment of dividends is improbable.

It is an object of the present invention to provide a method and system of generating trading strategies for dividend-based stocks, wherein the trading signals (from buy to sell or short-sell to buy cover) are in days.

It is a further object of the present invention to provide a method and system of generating trading strategies for dividend-based stocks, wherein specific Enter and Exit trading positions in terms of relative dates (e.g. one day after Dividend Declaration Date, two days after Ex-Dividend Date, etc).

It is yet a further object of the present invention to provide a method and system of generating trading strategies for dividend-based stocks, wherein the invention can secure profitable trades involving (i) dividend captures, (ii) dividend payout—when the invention recommends a short position from at least one day before Ex-Dividend Date through Ex-Dividend Date, and (iii) no dividend.

Other objects and advantages of the present invention will become apparent from the following description, taken in connection with the accompanying drawings, wherein, by way of illustration and example, an embodiment of the present invention is disclosed.

### SUMMARY OF THE INVENTION

In accordance with a first aspect of the present invention, there is provided a method of generating hedge fund trading strategies for dividend-based stocks, the method comprising the steps of: providing a system for generating trading strategies for dividend-based stocks, for each of a plurality of dividend-based stocks: loading a first database containing basic information of stock and a second database containing financial information of stock into the system computing maximum trading days of the stock, mapping of the first database and second database of the stock to a trading day and an alternative trading day, computing maximum number of trading pairs based on the maximum trading days of the stock, if trading long, computing historical returns for all trading pairs, computing buy/sell differences and actual trading dates and price of all trading pairs, if trading short, computing historical returns for all trading pairs, compute short/cover price differences and actual trading dates and price of all trading pairs, ranking a list of trading pairs based on one or more corresponding ranking criteria for trading long and trading short.

In accordance with a second aspect of the present invention, there is provided a method of
generating trading strategies for dividend-based stocks, the method comprising the steps of:
providing a system for generating trading strategies for dividend-based stocks, for each of a plurality of dividend-based stocks: loading a first database containing basic information of stock and a second database containing financial information of stock into the system, computing maximum trading days of the stock, mapping of the first database and second database of the stock to a trading day and an alternative trading day, computing maximum number of trading pairs based on the maximum trading days of the stock, if trading long, computing historical returns for all trading pairs, computing buy/sell differences and actual trading dates and price of all trading pairs, computing descriptive statistics and risk-performance measurement for each trading pair, if trading short, computing historical returns for all trading pairs, compute short/cover price differences and actual trading dates and price of all trading pairs, computing descriptive statistics and risk-performance measurement for each trading pair, computing a summary list of long trading signals and short trading signals,
ranking a list of trading pairs based on one or more corresponding ranking criteria for trading long and trading short, computing a visualisation of the ranking criteria of the trading pairs for long trading signals and short trading signals in a graphical format.

In accordance with a third aspect of the present invention, there is provided a system for generating trading strategies for dividend-based stocks, the system comprising: a memory storage medium for loading a first database of the stock, a second database of the stock and a third database of the stock, a processor, and a processor-readable storage medium in communication with the processor, wherein the processor-readable storage medium contains one or more programming instructions for generating of trading strategies for dividend-based equities.

### BRIEF DESCRIPTION OF THE DRAWINGS

The embodiments of the present invention will be discussed hereinafter in detail with reference to the accompanying in-line drawings. In addition, the general principles defined herein may be applied to other embodiments and applications without moving away from the spirit and scope of the invention. Consequently, the present invention is not intended to be limited to the embodiments shown, but is to be accorded the widest scope consistent with the principles and featured disclosed herein.

By way of example/illustration only, an embodiment of the invention is described more fully hereinafter with reference to the accompanying drawings, in which:

FIG. 1 illustrates a block diagram of the present invention.

FIG. 2 illustrates a flow chart of the present invention.

FIG. 3 illustrates some examples of the input data.

FIG. 4 illustrates a Maximum Trading Days periods.

FIG. 5 illustrates a TradingDate to TradingDay mapping.

FIG. 6 illustrates the generation of a Maximum Trading Pairs.

FIG. 7 illustrates a historical returns for a Long trading strategy for all Trading Pairs and each historical Ex-dividend Date.

FIG. 8 illustrates a buy/sell price difference and actual trading dates and price for all Trading Pairs.

FIG. 9 illustrates a computation of various descriptive statistics and risk-performance measurements for each Trading Pair based on Long Strategy.

FIG. 10 illustrates a historical returns for a Short trading strategy for all Trading Pairs and each historical Ex-dividend Date.

FIG. 11 illustrates a short/cover price difference and actual trading dates and price for all Trading Pairs.

FIG. 12 illustrates a computation of various descriptive statistics and risk-performance measurements for each Trading Pair based on Short Strategy.

FIG. 13 illustrates a summary of both Long and Short trading signals.

FIG. 14 illustrates a list of Trading Pairs and its corresponding average returns for both Long and Short strategies.

FIG. 15 illustrates a visualization of the average returns for both Long and Short strategies and its corresponding Trading Pair in a graphical format.

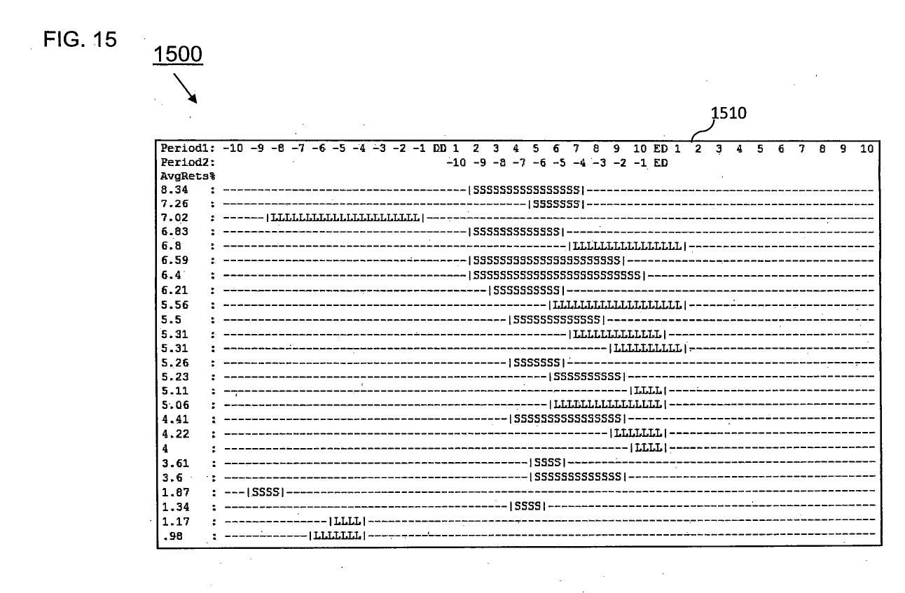

### DETAILED DESCRIPTION

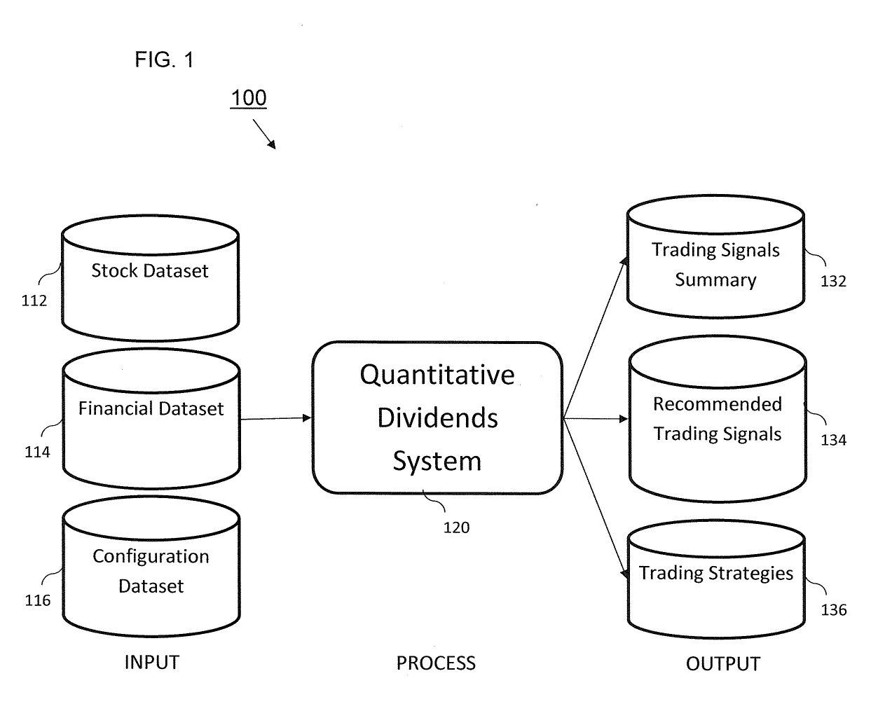

FIG. 1 illustrates a block diagram 100 in a preferred embodiment of the present invention. As shown, there are 3 sets of input database or dataset required:
First Database or Stock Dataset 112: Comprise of Stock Symbol (SS), Trading Date, Trading Date's Closing Price.
Second Database or Financial Dataset 114: Comprise of Stock Symbol, SS's Dividend Declaration Date (DD), SS's Ex-dividend Date (ED), SS's Dividend Amount.
Third Database or Configuration Dataset 116: Configuration data, comprising of a listing of Non-Trading Dates. It is submitted that the Configuration input dataset 116 is optional.

The main steps of the invention are within the system 120 (also known as Quantitative Dividend System), which has outputs of a Trading Signals Summary 132, Recommended Trading Signals 134 and Trading Strategies 136.

Within a financial market such as the stock market, there are stocks that pay dividends and those that do not pay dividend. For stocks that pay dividends (herein abbreviated as “DIVSTOCK”), there are 3 dates that are of relevant, the Dividend Declaration Date (DD), the Ex-dividend Date (ED) and Record Date (RD). When a company announces a dividend, it sets RD where the trader must be on the company's financial books as a shareholder in order to receive the dividend. The company may optionally also proclaims DD and ED. DD could be the same date as the announcement date or later. When the RD has been set by the company, the stock exchange will fix the ED which is typically two business days before the RD, below are some trading scenarios for dividend paying stock traders:
Traders will receive the dividend if they buy the DIVSTOCK before the ED and still own DIVSTOCK on the ED.
Traders who buy the DIVSTOCK before the ED and sell the DIVSTOCK on or after the ED are not entitled to the dividend.
Traders do not own the DIVSTOCK a day before the ED and buy the DIVSTOCK only on the ED are also not entitled to the dividend.
Traders who sell short a DIVSTOCK before the ED and buy cover the DIVSTOCK on or after the ED are required to pay the dividend either to the company or the brokerage house.

In general, traders that buy and sell a stock are using a trading strategy call Long strategy (herein abbreviated as “LONG”). On the other hand, traders that sell short and later buy cover a stock is using a trading strategy call Short strategy (herein abbreviated as “SHORT”).

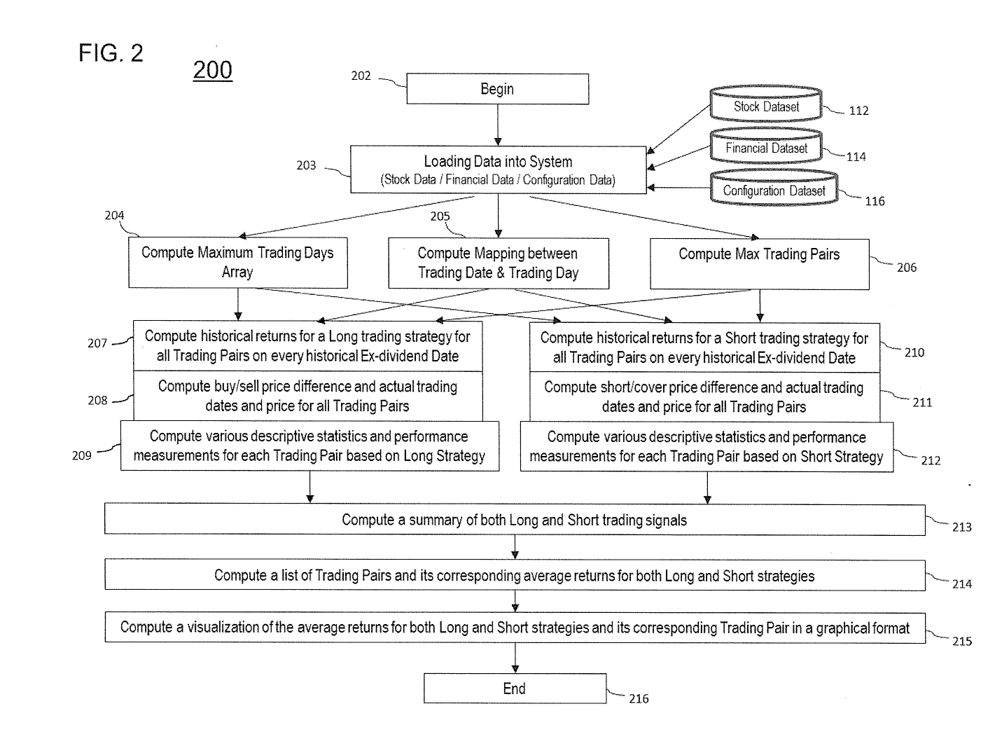

FIG. 2 contains the flow chart in a preferred embodiment of the present invention 200. More specifically, the new steps are: 204 to 215. Within steps 204 to 215, the essential parts are steps 204, 205, 206, 207, 208, 210, 211, 214 and the rest (optional parts) are steps 209, 212, 213 and 215.

Referring to FIG. 2, processing commences in step 202.

In step 203, the first database or Stock Dataset 112, second database or Financial Dataset 114 and third database or Configuration Dataset 116 are loaded into the memory storage medium of the system 120. The system 120 further comprise of a processor, a processor-readable storage medium containing one or more programming instructions relating to the generation of trading strategies for dividend-based equities. The programming instructions are installed in a computing program and also a computing program product. It is submitted that the computing program comprise of program code means for performing all the steps 202 to 216. It is further submitted that the computing program product comprise of program code means stored on a computer readable medium for performing all the steps 202 to 216 when the program product is run on a computer.

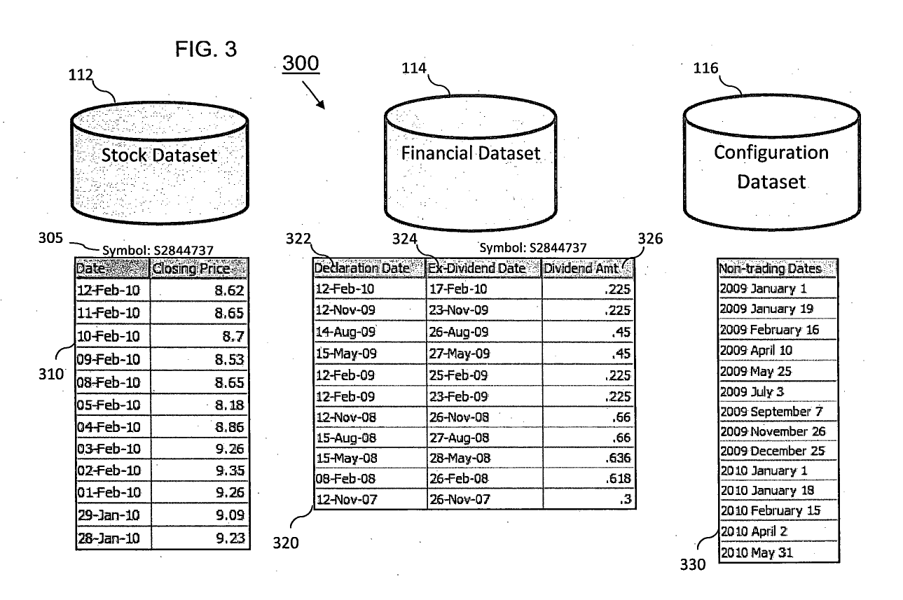

More specifically, referring to FIG. 3 for more details 300 on the nature of Stock Dataset 112, Financial Dataset 114 and Configuration Dataset 116 in an example embodiment of the present invention. A stock dataset 112 containing basic information such as, a stock symbol (SS) 305, SS's corresponding historical trading dates and closing price is shown in the first dataset 310. In another embodiment of the present invention, closing price can be substituted with opening price, high price, low price, average of high+low prices or average of high+low+open+close prices.

A financial dataset 114 containing financial information such as, SS's dividend Declaration Date (DD) 322, Ex-dividend Date (ED) 324, and Dividend Amount (DA) 326 is shown in a second dataset 320. The Ex-dividend Date (ED) of the stock is at least one day before the current dat. The dividend Declaration Date (DD) of the stock comes before the Ex-dividend Date (ED) of the stock. The dividend Declaration Date (DD) comes before the Record Date (RD) of the stock.

A configuration dataset 116 containing Non-trading Dates is shown in a third dataset 330.

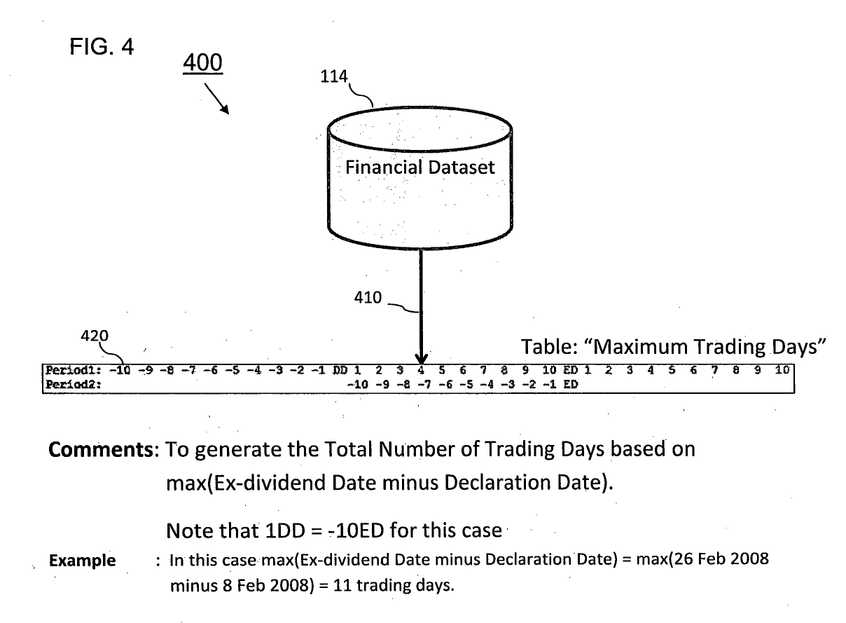

In step 204, a first table 420 show the Maximum Trading Days (also known as Maximum Trading Days table) is generated in an example embodiment of the present invention. More specifically, referring to FIG. 4,
i. As an option, at least one day before the DD is included (in FIG. 4, 10 days before DD are included, i.e. from −1, −2, to . . . −10, also denoted as −1 dd, −2 dd, . . . , −10 dd).
ii. Also as an option, at least one day after ED is included (in FIG. 4, 10 days after ED are included, also denoted as 1 ed, 2 ed, . . . , 10 ed).
iii. The number of days between DD and ED is determined by the maximum number of days between (exclusive) Ex-Dividend Date 324 and Declaration Date 322.
iv. In this illustration 400, the maximum number days between 324 and 322 is 10 (ten days), and is denoted as 1 dd, 2 dd, . . . , 10 dd (SEQ1).
v. Sequence 3 i+“DD”+3 iv+“ED”+3 ii is categorized as Period1.
vi. An equivalent sequence to SEQ1, relative to ED is −10 ed, −9 ed, . . . , −1 ed (categorised as Period2).

A trading day (herein symbolised as TradingDay) is defined as any of these records: −1 dd, −2 dd, . . . , −Ndd, DD, 1 dd, 2 dd, . . . , Ndd, ED, 1 ed, 2 ed, . . . , Ned, −1 ed, −2 ed, . . . , −Ndd, where N is a non-zero integer.

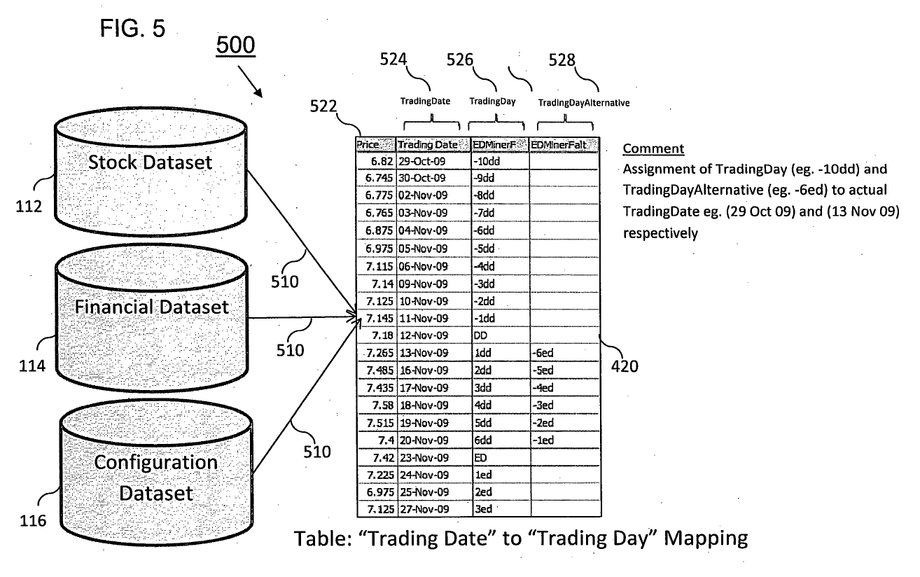

In step 205 and referring to FIG. 5, a mapping for each record (SS, Trading Date and Closing Price) in the Stock Dataset 112 and its corresponding TradingDay 526 (also known as trading day) for Period1 and its corresponding TradingDayAlternative (also known as alternative trading day) for Period2 528 in an example embodiment of the present invention. In cases where the Ex-dividend Date is later than the most recent Trading Date 524, a projection of date is can be done by taking into consideration Non-trading Dates from the Configuration Dataset 116. A second table 522 is an illustration is derived from stock symbol S2844737. Closing Price could also be substituted with other prices from the trading date itself—such as Opening Price, High Price, Low Price, Average of High+Low Prices, Average of High+Low+Open+Close Prices, etc.

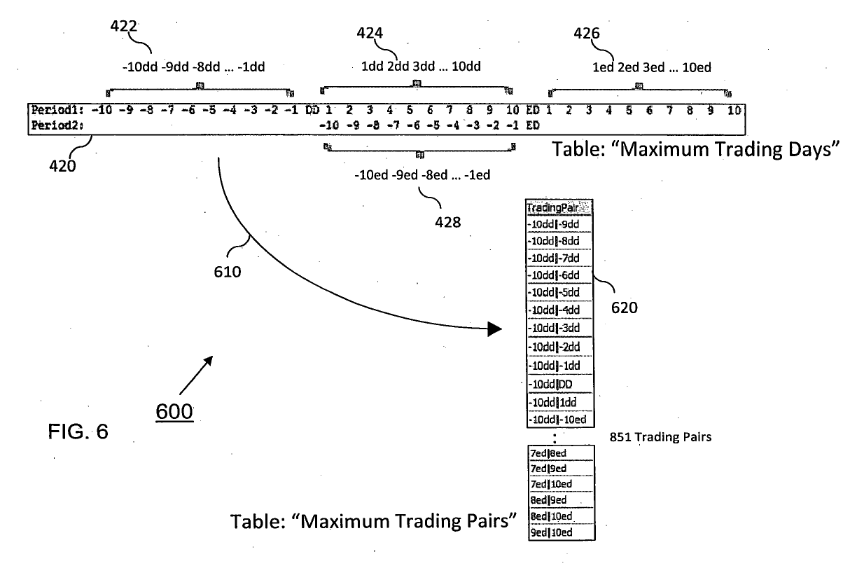

In step 206 and referring to FIG. 6, a third table 620 showing the Maximum Number of Trading Pairs is generated 610 based on the first table 420 in an example embodiment of the present invention. Each TradingPair comprise of two Trading Days where:
For LONG, the first Trading Day is a Buy signal, and the second Trading Day is a Sell signal, and
For SHORT, the first Trading Day is a Sell short signal, and the second Trading Day is Buy signal.

Using a simple example, if there are 5 trading days as shown below:

| Trading Days | −1 | DD | 1 | ED | 1 |
|---|---|---|---|---|---|
| Row 1 | Buy | Sell | Sell | Sell | Sell |
| Row 2 | | Buy | Sell | Sell | Sell |
| Row 3 | | | Buy | Sell | Sell |
| Row 4 | | | | Buy | Sell |

The list of TradingPair (of Period1) for these 5 trading days would be:
Corresponding to Row 1: −1 dd|DD, −1 dd|1dd, −1 dd|ED, −1dd|1 ed
Corresponding to Row 2: DD|1 dd, DD|ED, DD|1 ed
Corresponding to Row 3: 1 dd|ED, 1 dd|1 ed
Corresponding to Row 4: ED|1 ed
Steps 207 to 209 are for LONG,

Other methods which can be used to generate all possible trading pair combination include Monte Carlo simulation and Genetic Algorithms.

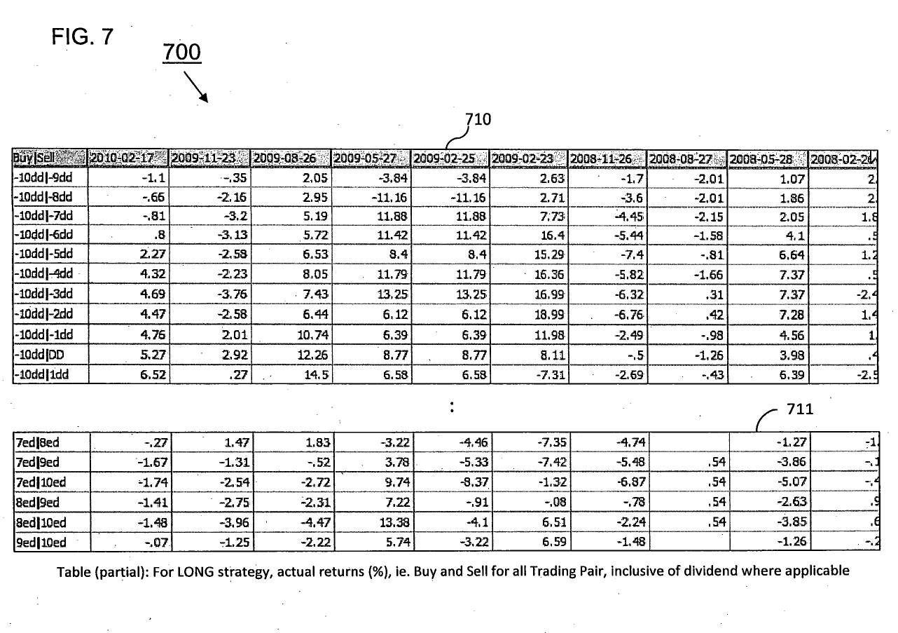

In step 207, referring to FIG. 7, a fourth table 710 is generated based on the computed historical returns from each TradingPair 620 with respective to individual Trading Date 524 of the Trading Day 526 in an example embodiment of the present invention. The basic formula, Computed returns (%) or CR_{L} where

$${CR}_{L} = ( \frac{{ρ}_{2} - {ρ}_{1}}{{ρ}_{1}} ) * 100 \%$$

In cases where the first Trading Day is before ED and the second Trading Day is on or after ED, the computed returns include the dividend, the modified formula, Computed returns with Dividends (%) or CRD_{L} where

$${CRD}_{L} = ( \frac{{ρ}_{2} - {ρ}_{1}}{{ρ}_{1}} + \frac{δ}{{ρ}_{1}} ) * 100 \%$$

where ρ₁ is first Trading Day price, ρ₂ is second Trading Day price and δ is the receiving dividend amount.

The representative date used in table 710 is the Ex-dividend Date 324 of each record in Financial Dataset 114.

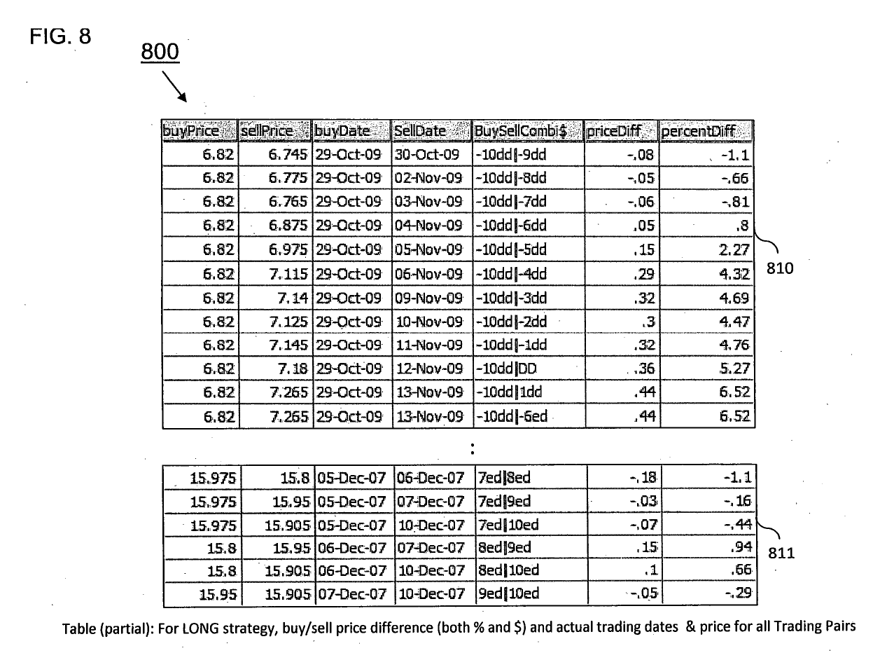

In step 208, referring to FIG. 8, a fifth table 800 is generated based on table 710 and the second table 522 in an example embodiment of the present invention. As shown, the buy/sell price differences and actual trading dates and prices for all trading pairs are computed.

In addition, the Absolute Price Difference ($) is also generated. The basic formula, Absolute Price Difference ($) or APD_{L}, where

APD_{L}=ρ₂−ρ₁

In cases where the first Trading Day is before ED and the second Trading Day is on or after ED, the computed returns include the dividend, the modified formula, Absolute Price Difference with Dividends ($) or APDD_{L} where

APDD_{L}=(ρ₂−ρ₁)+δ

As the fifth table 800 is a lengthy table and the first few records for table 800 are shown in 810 while the last few records are shown in 811.

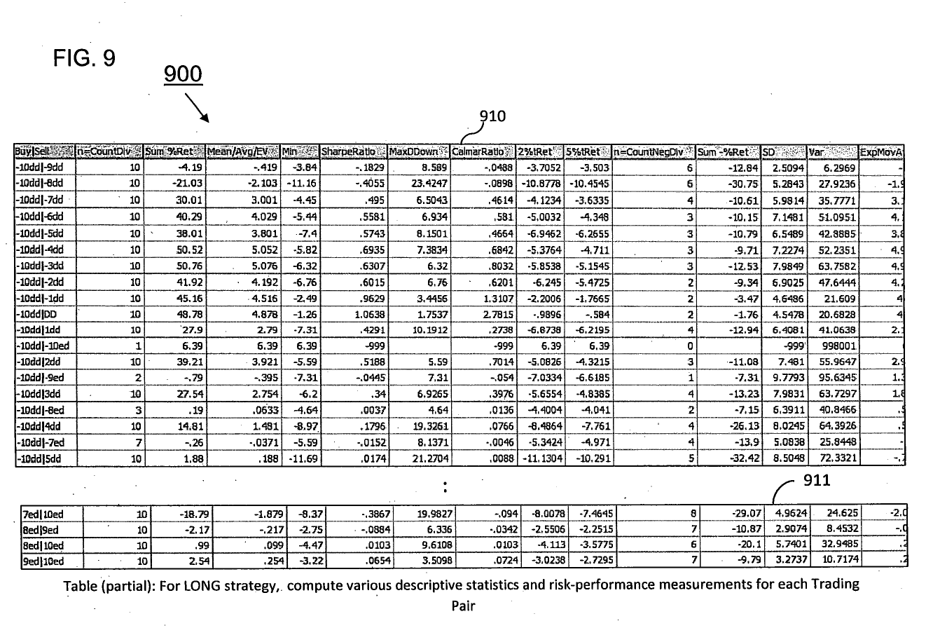

In step 209, referring to FIG. 9, a sixth table 900 is generated based from table 800 for each TradingPair 620 in an example embodiment of the present invention. For each TradingPair 620, various statistical and risk-performance measurements are generated. Examples of statistical measurements include arithmetic mean, geometric mean, harmonic mean, median, mode, standard deviation, coefficient of variation, percentile, absolute deviation, variance, semi-variance, skewness, kurtosis, moments, L-moments, etc. Examples of risk-performance measurements for returns include Sharpe ratio, Calmar ratio, Sortino ratio, Treynor ratio, Upside potential ratio, Jensen's alpha, beta coefficient, dividend payout ratio, dividend yield, etc.

Steps 210 to 212 are for SHORT.

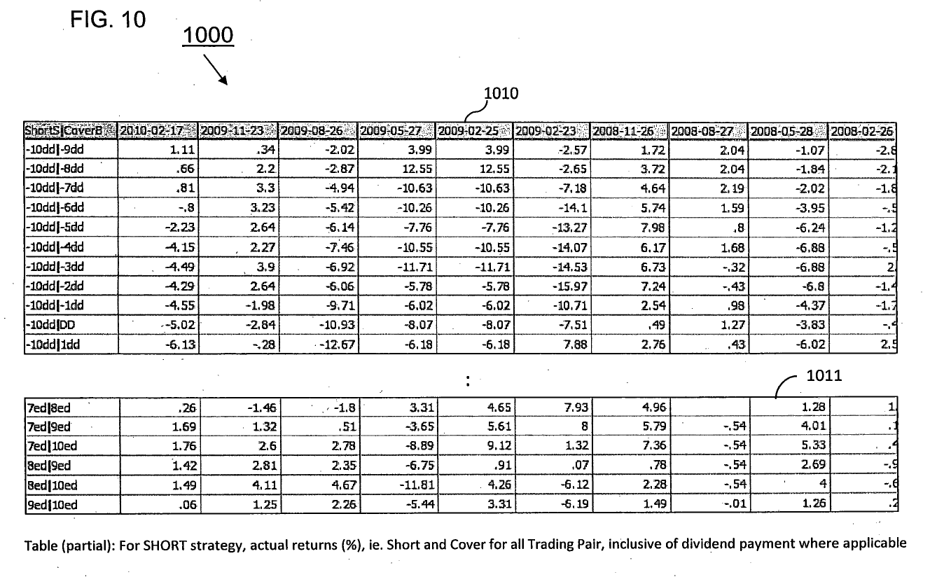

In step 210, referring to FIG. 10, a seventh table 1000 is generated based on the computed historical returns from each TradingPair 620 with respective to individual Trading Date 524 of the Trading Day 526 in an example embodiment of the present invention. The basic formula, Computed returns (%) or CR_{S} where

$${CR}_{S} = ( \frac{{ρ}_{1} - {ρ}_{2}}{{ρ}_{2}} ) * 100 \%$$

In cases where the first Trading Day is before ED and the second Trading Day is on or after ED, the computed returns include paying of dividend, the modified formula, Computed returns with Dividends (%) or CRD_{S} where

$${CRD}_{S} = ( \frac{{ρ}_{1} - {ρ}_{2}}{{ρ}_{2}} - \frac{δ}{{ρ}_{2}} ) * 100 \%$$

where ρ₁ is first Trading Day price, ρ₂ is second Trading Day price and δ is the dividend payment amount.

The representative date used in table 1010 is the Ex-dividend Date 324 of each record in Financial Dataset 114.

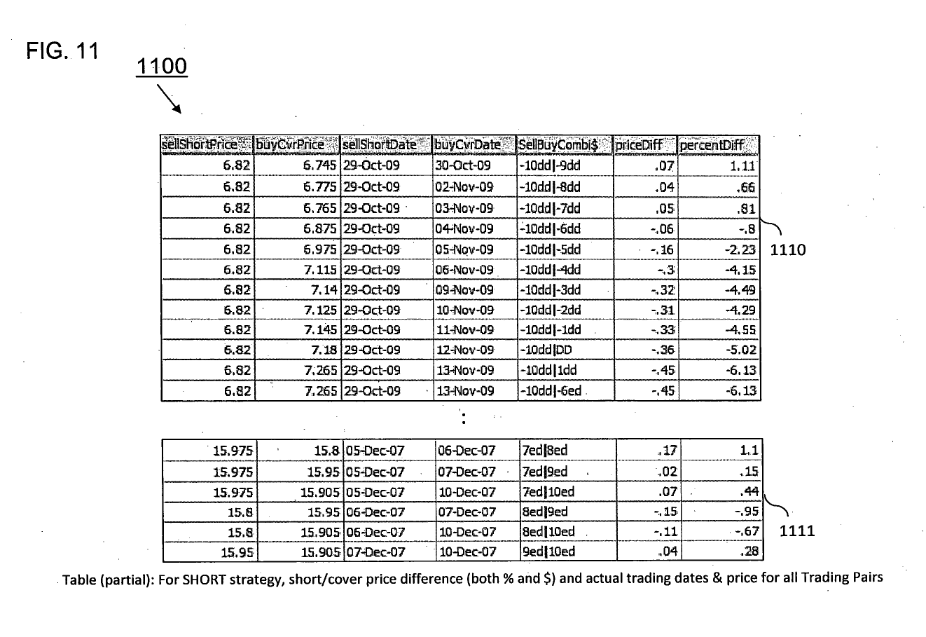

In step 211, referring to FIG. 11, an eighth table 1100 is generated based on table 1110 and the second table 522 in an example embodiment of the present invention. As shown, the short/cover price differences and actual trading dates and prices for all trading pairs are computed.

In addition, the Absolute Price Difference ($) is also generated. The basic formula, Absolute Price Difference ($) or APD_{S} where

APD_{S}=ρ₁−ρ₂

In cases where the first Trading Day is before ED and the second Trading Day is on or after ED, the computed returns include the dividend, the modified formula, Absolute Price Difference with Dividends ($) or APDD_{S} where

APDD_{S}=(ρ₁−92 ₂)−δ

As the eighth table 1100 is a lengthy table and the first few records for table 1100 are shown in 1110 while the last few records are shown in 1111.

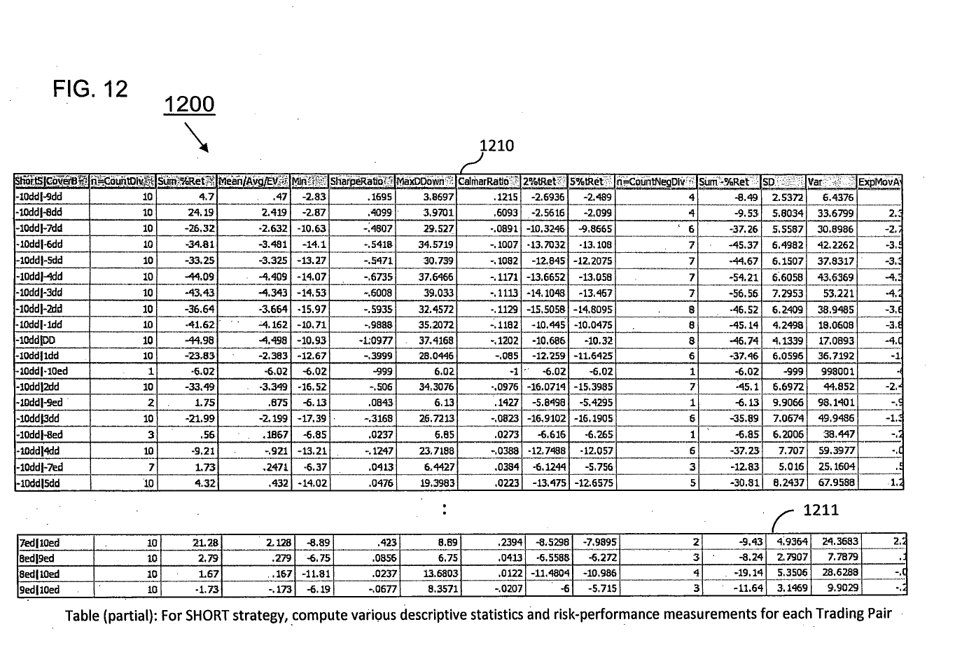

In step 212, referring to FIG. 12, a ninth table 1200 is generated based from table 1100 for each TradingPair 620 in an example embodiment of the present invention. For each TradingPair 620, various statistical and risk-performance measurements are generated. Examples of statistical measurements include arithmetic mean, geometric mean, harmonic mean, median, mode, standard deviation, coefficient of variation, percentile, absolute deviation, variance, semi-variance, skewness, kurtosis, moments, L-moments, etc. Examples of risk-performance measurements include Sharpe ratio, Calmar ratio, Sortino ratio, Treynor ratio, Upside potential ratio, Jensen's alpha, beta coefficient, dividend payout ratio, dividend yield, etc.

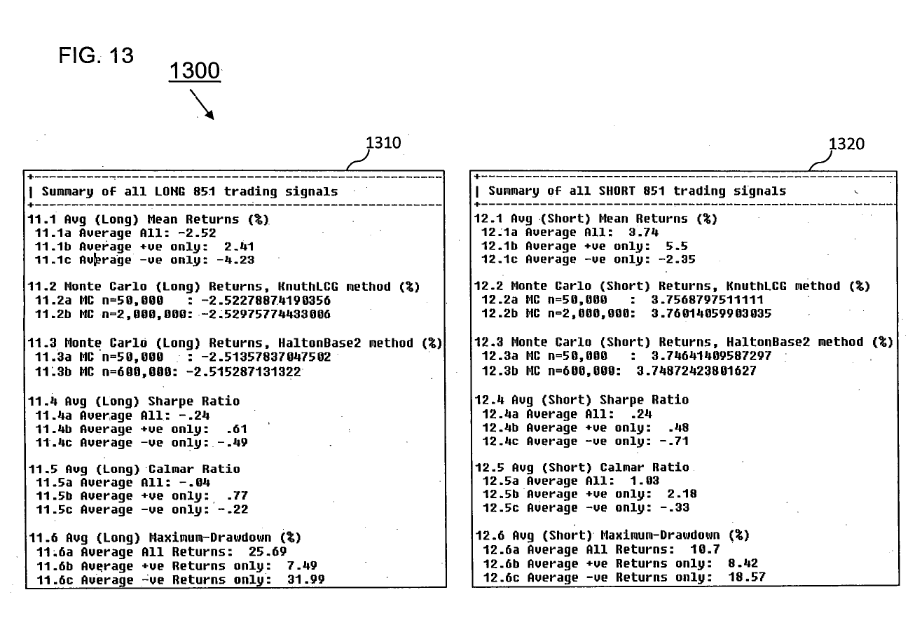

In step 213, referring to FIG. 13, a further statistical and risk-performance summary are generated 1300 in an example embodiment of the present invention.
The summary for the LONG trading signals 1310 is based on the data in sixth table 900.
The summary for the SHORT trading signals 1320 is based on the data in ninth table 1210.

For each TradingPair 620, the statistical summary includes average of the mean returns, the Monte Carlo simulation on the average returns, etc. Moreover, for each TradingPair 620, the risk-performance summary includes average Sharpe ratio, average Calmar ratio, average Sortino ratio, average Treynor ratio, average Upside potential ratio, average Jensen's alpha, average beta coefficient, etc.

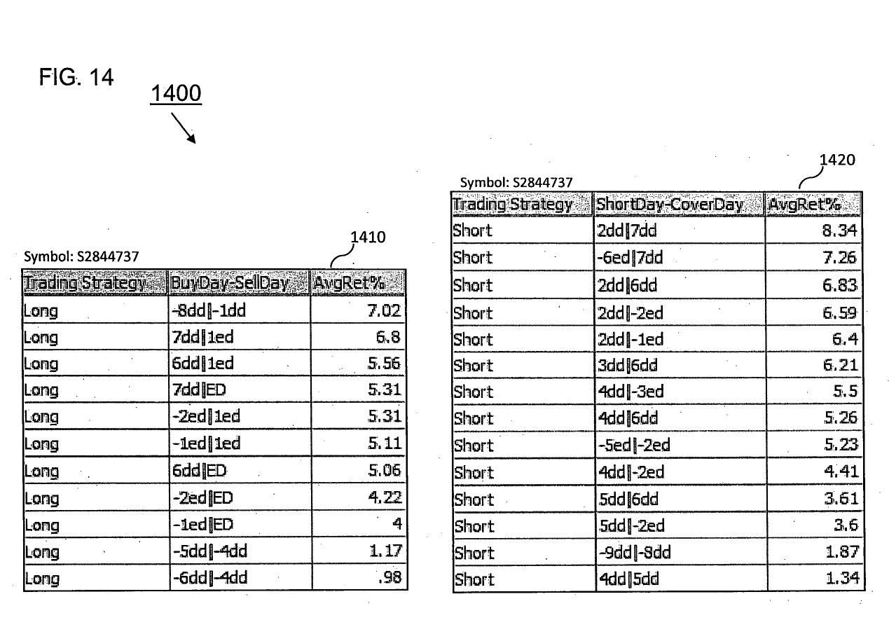

In step 214, referring to FIG. 14, a list of recommended LONG trading signals is generated in a tenth table 1410 in an example embodiment of the present invention. As shown, a list of trading pairs is ranked based on one or more corresponding ranking criteria of an average returns for both Long and Short strategies are computed. In other embodiment, average returns may be substituted with other measurements. The ranking criteria can be from one or more of the statistical or risk-performance measurements in the sixth table 900.

In tenth table 1400, the list of recommended LONG trading signals is ranked by the average returns (%) of its TradingPair.

Correspondingly, a list of recommended SHORT trading signals is also generated in an eleventh table 1420 in an example embodiment of the present invention. In eleventh table 1420, the list of recommended SHORT trading signals is ranked by the average returns (%) of its TradingPair.

In step 215, visualization 1510 integrating the results from the maximum trading day table in FIG. 4 and the list of recommended LONG and SHORT trading signals in FIG. 14 is shown in an example embodiment of the present invention.

From the list of recommended trading signals, the trader can now decide if he/she wants to proceed with the trading using any of the trading signals.

It is submitted that the commercial applicability of the present invention can also be used in hedge fund strategies, dividend policies decision-making, trading strategies and investing strategies.

1. A method of generating trading strategies for dividend-based stocks, the method comprising the steps of:
providing a system for generating trading strategies for dividend-based stocks, for each of a plurality of dividend-based stocks,
loading a first database containing basic information of stock and a second database containing financial information of stock into the system,
computing maximum trading days of the stock,
mapping of the first database and second database of the stock to a trading day and an alternative trading day,
computing maximum number of trading pairs based on the maximum trading days of the stock,
if trading long, computing historical returns for all trading pairs, computing buy/sell differences and actual trading dates and price of all trading pairs,
if trading short, computing historical returns for all trading pairs, compute short/cover price differences and actual trading dates and price of all trading pairs, and
ranking a list of trading pairs based on one or more corresponding ranking criteria for trading long and trading short.

2. The method according to claim 1, wherein the basic information of stock comprises of symbol of the stock, trading date of the stock and closing price of the trading date.

3. The method according to claim 1 wherein the financial information of stock comprises of symbol of the stock, ex-dividend declaration date of the stock and dividend amount of the stock.

4. The method according to claim 3, wherein the ex-dividend date of the stock is at least one day before current date.

5. The method according to claim 3, wherein the financial information of stock further comprises of dividend declaration date of the stock.

6. The method according to claim 3, wherein the dividend declaration date of the stock comes before the ex-dividend date of the stock.

7. The method according to claim 3, wherein the dividend declaration date of the stock comes before record date of the stock.

8. The method according to claim 1, wherein the dividend-based stocks further comprises of a third database containing a list of non-trading dates.

9. The method according to claim 1, wherein the trading pair comprise of a first trading day and a second trading day.

10. The method according to claim 9, wherein the first trading day being a buy signal and a second trading pair being a sell signal in the long strategy.

11. The method according to claim 9, wherein the trading pair comprise of a first trading day being a sell short signal and a second trading pair being a buy signal in the short strategy.

12. The method according to claim 1, wherein each of the trading pair generates one or more statistical measurements and risk-performance measurements.

13. The method according to claim 12, wherein the statistical measurement may be any one or more of arithmetic mean, geometric mean, harmonic mean, median, mode, standard deviation, coefficient of variation, percentile, absolute deviation, variance, semi-variance, skewness, kurtosis, moments and L-moments.

14. The method according to claim 12, wherein the risk-performance measurement may be any one or more of Sharpe ratio, Calmar ratio, Sortino ratio, Treynor ratio, Upside potential ratio, Jensen's alpha, beta coefficient, dividend payout ratio and dividend yield.

15. A method of generating hedge fund trading strategies for dividend-based stocks, the method comprising the steps of:
providing a system for generating trading strategies for dividend-based stocks,
for each of a plurality of dividend-based stocks,
loading a first database containing basic information of stock and a second database containing financial information of stock into the system,
computing maximum trading days of the stock,
mapping of the first database and second database of the stock to a trading day and an alternative trading day,
computing maximum number of trading pairs based on the maximum trading days of the stock,
if trading long, computing historical returns for all trading pairs, computing buy/sell differences and actual trading dates and price of all trading pairs, computing descriptive statistics and risk-performance measurement for each trading pair,
if trading short, computing historical returns for all trading pairs, compute short/cover price differences and actual trading dates and price of all trading pairs, computing descriptive statistics and risk-performance measurement for each trading pair,
computing a summary list of long trading signals and short trading signals,
ranking a list of trading pairs based on one or more corresponding ranking criteria for trading long and trading short, and
computing a visualisation of the ranking criteria of the trading pairs for long trading signals and short trading signals in a graphical format.

16. The method according to claim 15, wherein the basic information of stock comprises of symbol of the stock, trading date of the stock and closing price of the trading date.

17. The method according to claim 15, wherein the financial information of stock comprises of symbol of the stock, ex-dividend declaration date of the stock and dividend amount of the stock.

18. The method according to claim 17, wherein the ex-dividend date of the stock is at least one day before current date.

19. The method according to claim 17, wherein the financial information of stock further comprises of dividend declaration date of the stock.

20. The method according to claim 17, wherein the dividend declaration date of the stock comes before the ex-dividend date of the stock.

21. The method according to claim 17, wherein the dividend declaration date of the stock comes before record date of the stock.

22. The method according to claim 15, wherein the dividend-based stocks further comprises of a third database containing a list of non-trading dates.

23. The method according to claim 15, wherein the trading pair comprises of a first trading day and a second trading day.

24. The method according to claim 23, wherein the first trading day being a buy signal and a second trading pair being a sell signal in the long strategy.

25. The method according to claim 23, wherein the trading pair comprise of a first trading day being a sell short signal and a second trading pair being a buy signal in the short strategy.

26. The method according to claim 15, wherein each of the trading pair generates one or more of statistical measurements and risk-performance measurements.

27. The method according to claim 26, wherein the statistical measurement may be any one or more of arithmetic mean, geometric mean, harmonic mean, median, mode, standard deviation, coefficient of variation, percentile, absolute deviation, variance, semi-variance, skewness, kurtosis, moments and L-moments.

28. The method according to claim 26, wherein the risk-performance measurement may be any one or more of Sharpe ratio, Calmar ratio, Sortino ratio, Treynor ratio, Upside potential ratio, Jensen's alpha, beta coefficient, dividend payout ratio and dividend yield.

29. A system for generating trading strategies for dividend-based stocks, the system comprising:
a memory storage medium for loading a first database of the stock, a second database of the stock and a third database of the stock,
a processor, and
a processor-readable storage medium in communication with the processor,
wherein the processor-readable storage medium contains one or more programming instructions for generating of trading strategies for dividend-based equities.

30. A computer program comprising program code means for performing all the steps of claim 1 when the program is run on a computer.

31. A computer program product comprising program code means stored on a computer readable medium for performing the method of claim 1 when the program product is run on a computer.
